(19) United States
(12) Patent Application Publication
(10) Pub. No.: US 2005/0283276 A1
(43) Pub. Date: Dec. 22, 2005

(54) Real time subsea monitoring and control system for pipelines

(76) Inventors: Clifford Neal Prescott, Houston, TX (US); David V. Brower, Houston, TX (US)

Correspondence Address: Charles D. Gunter, Jr.;Whitaker, Chalk, Swindle & Sawyer, LLP, 301 Commerce Street, Ste. 3500, Fort Worth, TX, 76102-4186, US

(21) Appl. No.: 11/131,808

(22) Filed: May 18, 2005

Related U.S. Application Data
(60) Provisional application No. 60/575,433, filed on May 28, 2004.
(60) Provisional application No. 60/576,514, filed on Jun. 2, 2004.

(51) Int. Cl. G05D 7/00

(52) U.S. Cl. 700/282; 702/49

(57) ABSTRACT

A method for monitoring and maintaining a pipeline is shown which includes installing a monitoring system for measuring at least one parameter of interest, the monitoring system including various monitoring sensors placed at selected locations along the pipeline. A series of measurements are taken using the monitoring sensors in real time. The measurements are analyzed to identify anomalous conditions existing in the pipeline being monitored. An autoadaptive corrective action is implemented based upon the real time measurement of the parameter of interest.

### A. CROSS REFERENCE TO RELATED APPLICATIONS

The present application claims priority from earlier filed U. S. Provisional Patent Application Ser. No. 60/575,433, filed May 28, 2004 and entitled “Real Time Subsea Monitoring and Control for Pipelines” and U.S. Provisional Patent Application Ser. No. 60/576,514, filed Jun. 2, 2004, and entitled “Real Time Subsea Monitoring and Control for Pipelines II.”

### BACKGROUND OF THE INVENTION

B: Field of the Invention

This invention relates to the monitoring and maintenance of pipelines and more particularly to a system for monitoring a pipeline, particularly an undersea pipeline, which is auto adaptive to the environment so that real-time problem identification and corrective action can be implemented.

C. Description of the Prior Art

Pipelines are used in a wide variety of industrial settings. For example, fluids, such as oil and gas, as well as particulate, and other small solids suspended in fluids, are routinely transported using underground pipelines. In addition to underground and surface pipelines, other fluid conveying pipeline installations include subsea or marine installations. Subsea pipelines carry large quantities of oil and gas products indispensable to energy-related industries, often under tremendous pressure and at low temperatures and at high flow rates.

A need exists for improved systems for monitoring and maintaining pipelines of all of the above types, and particularly subsea pipelines. For example, offshore hydrocarbon recovery operations are increasingly moving into deeper water and more remote locations. Subsea pipelines are often used to tie satellite wells, which are completed at the sea floor, to remote platforms or other facilities. In some cases, these subsea pipelines extend through water that is thousands of feet deep, where temperatures of the water near the sea floor is relatively cold, on the order of 40° F., for example. The hydrocarbon fluids, usually produced along with some water, reach the sea floor at much higher temperatures, characteristic of depths thousands of feet below the sea floor. When the hydrocarbon fluids and any water present begin to cool, phenomena occur that may significantly affect flow of the fluids through the pipelines. Some crude oils become very viscous or deposit paraffin when the temperature of the oil drops, thereby impeding the flow of the oil. Hydrocarbon gas under pressure combines with water at reduced temperatures to form solid materials called hydrates. Hydrates can plug pipelines and the plugs are very difficult to remove. In deep water, conventional methods of depressurizing the flow line to remove a hydrate plug may not be effective. Higher pressures in the line and uneven sea floor topography require excessive time and may create operational problems and be costly in terms of lost production.

The presently available techniques for detecting and removing such materials as paraffins and asphaltenes, inorganic materials such as scale, and more complex products such as the hydrates are all less than completely satisfactory. For example, it is known to use a pipeline inspection apparatus that includes a vehicle capable of moving along the interior of the pipe by the flow of fluid through the pipe to inspect the pipe for location of anomalies. Such prior art inspection vehicles, commonly referred to as “pigs,” have typically included various means of urging the pigs along the interior of the pipe including rubber seals or even spring-loaded wheels. The wheel equipped pigs have typically included odometers for counting the number of rotations of the wheels. The wipers or wheels of such pigs have included devices such as ultrasound receivers, odometers, calipers, and other electrical devices for making measurements of various kinds. After deposits have been detected, another version of pigs can be used to remove the deposits from the wall of the pipelines.

While the use of pigs is generally accepted in the industry, the technique is not without problems. For example, a pig, depending upon its purpose, can significantly reduce the flow of materials through a pipeline while the pig is deployed within the pipeline. In some cases, the pipeline may have become so narrowed or blocked that a pig can be lost within a pipeline and require a reverse flush of the pipeline or other even more extreme measures. In some applications, a pipeline must be shutdown completely during pigging operations. This type of downtime inherently causes a loss in production, which can be extremely costly in the case of subsea pipelines.

It would be desirable, therefore, to provide a system for monitoring and maintaining such pipelines which would predict and allow proactive measures to be taken to avoid the problems associated with pipeline fouling or plugging or other deleterious conditions in the pipeline.

### SUMMARY OF THE INVENTION

The present invention comprises a method for monitoring and maintaining a pipeline which both predicts and allows proactive measures to be taken to avoid the problems associated with pipeline fouling or plugging or other deleterious conditions in the pipeline as discussed above. In the method of the invention, a monitoring system is installed on the pipeline for measuring at least one parameter of interest. The monitoring system including a plurality of monitoring sensors placed at selected locations along the pipeline. In the method of the invention, a series of measurements are taken using the monitoring sensors in real time. The measurements are analyzed to identify anomalous conditions existing in the pipeline being monitored. Autoadaptive corrective action is implemented based upon the real time measurement of the parameter of interest.

In a particularly preferred embodiment of the system of the invention, a monitoring system is installed for measuring at least one parameter of interest selected from the group consisting of temperature, pressure, flow and level within the pipeline. The monitoring system includes a plurality of monitoring sensors placed at selected locations along the pipeline, the monitoring sensors comprising a fiber optic distributed sensor array. A series of measurements is taken using the monitoring sensors in real time. The measurements are analyzed, as before, to identify anomalous conditions existing in the pipeline being monitored and an autoadaptive corrective action is implemented based upon the real time measurement of the parameter of interest.

The anomalous condition being analyzed may be related to a build up of one or more undesirable materials within the interior of the pipeline selected from the group consisting of paraffins, asphaltenes, scale, water, hydrates, and mixtures thereof. Preferably, the fiber optic distributed sensor array is used to measure temperature on the outside of the pipeline at selected spaced apart locations with the temperature measurements being used to prepare a temperature profile, the profile being prepared in real time using a computer.

The step of implementing an autoadaptive corrective action based upon the real time measurement of the parameter of interest may include the step of treating the pipeline by introducing a chemical agent into the interior of the pipeline to reduce or prevent the accumulation of material within the pipeline. The step of implementing an auto adaptive corrective action based upon the real time measurement of the parameter of interest may also include the step of applying heat by means of an external heat source to the exterior of the pipeline to prevent or break up the undesirable build-up within the pipeline interior.

Additional objects, features and advantages will be apparent in the written description which follows.

### BRIEF DESCRIPTION OF THE DRAWINGS

FIG. 1 is a schematic illustration of a subsea oil and gas production installation, including a pipeline including the elements of the present invention.

FIG. 2 is a schematic illustration of the control loop used in the method of the invention.

FIG. 3 is a partial cut-away view of a section of pipeline equipped with a fiber optic sensor array of the type used in practicing the method of the invention.

### DETAILED DESCRIPTION OF THE INVENTION

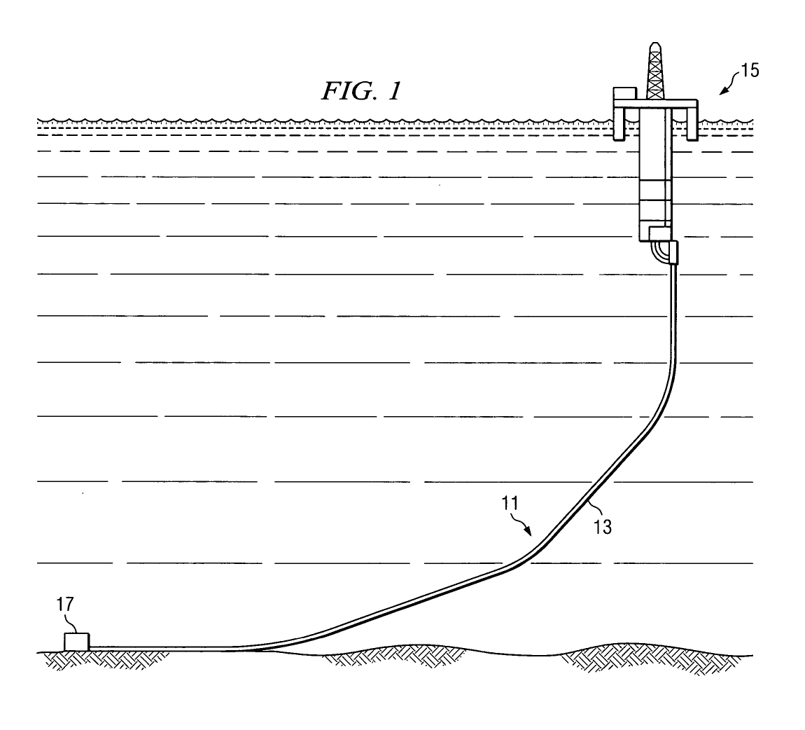

Turning to FIG. 1, there is shown a subsea well head and production pipeline installation of the type under consideration designated generally as 11. The system of the invention is used to, for example, monitor the build up of materials within the interior of the pipeline and for implementing corrective action when anomalous conditions are detected. However, any of a wide variety of pipeline conditions can be monitored in addition to accumulations within the pipeline interior. The present inventive method involves the integration of the latest technology advancements in the petroleum industry coupled with standard state-of-the-art pipeline technology. The result is a pipeline that is auto adaptive to the environment so that realtime problem identification and corrective action can be implemented. Potential pipeline problems will be mitigated to avoid costly down time and repair. The technology will significantly reduce environmental contamination concerns. It is expected that years of trouble free pipeline usage will be possible with an enhanced overall service life expectancy.

Pipeline monitoring will be provided with advanced instrumentation that has been developed, proven and deployed in recent deepwater projects. Fiber-optic sensors and new data acquisition systems will be deployed to provide real-time pipeline and riser monitoring on a variety of fields. Fiber-optic sensors are ideally suited for subsea applications for several reasons: they have multiplexing capability, they are immune to electromagnetic interference (EMI), they have very little signal loss over extremely long distances, small size, corrosion resistance, and ease of use and handling. Advanced sensor data will feed the data analysis and control algorithms for processing through the latest SCADA (supervisory and control data acquisition) technology available.

Smart pipeline technology involves the detection and realtime monitoring of desired flow assurance parameters followed by implementation of corrective action when anomalous conditions are identified. The smart pipeline technology allows for autoadaptive measures to ensure trouble free operation of the entire pipeline system. Realtime monitoring and control of flow assurance issues drive the development of smart pipelines in oil & gas reservoirs for both onshore and offshore deepwater environments. A key feature of this technology is to develop full knowledge of flow assurance parameters from the reservoir to the sales point in pipelines and production risers; and from the wellhead through drilling risers to the rig when developing a field.

The method of the invention provides a methodology to offer smart pipeline technology, including real-time, on-line monitoring and control system for subsea production and pipelines. The instrumentation is based on fiber optic technology. The system includes problem prevention or mitigation with early detection and proactive intervention to monitored concerns. By applying new developments in the field of optic fiber monitoring, it is possible to provide predictive tools for pipeline operators. This has resulted in the development of a smart field control system with automated data analysis and response. The ultimate goal is an integrated operations control system capable of providing optimum performance.

There are a number of operation and mechanical parameters which may be monitored or derived using this data system. The data acquired may be used to predict the onset of problems hence allowing timely corrective action. The result is avoidance of costly down time and mitigation of potential environmental contamination from pipeline failure. The measurement features of the new smart pipeline method include: hydrate build up and prediction; free span and vortex induced vibration identification; leak detection; slug prediction, detection and suppression; fatigue life prediction; pig tracking; wax/paraffin build up prediction; pipeline cool down; earthquake or earth movements; river/stream crossing integrity; solids/liquids accumulations in prone areas; pipeline displacements for stress, strain, fatigue, and ;insulation anomalies in LNG pipelines.

Fiber optic sensors provide much of the real time strain, temperature, vibration, and flow monitoring for pipelines in deepwater. However, conventional sensor systems are incorporated as required.

Fiber optic sensors are attractive in deepwater applications because of their multiplexing capability, immunity to electromagnetic interference, ruggedness and long distance signal transmission ability. Feasibility of using fiberoptic sensors has been demonstrated through full scale riser deployment in the Gulf of Mexico on steel centenary risers and drilling risers. Key features of fiber optic sensor technology include the follows attributes: They are lightweight and small in size; they are rugged and have a long life—sensors will last indefinitely; they are inert and corrosion resistant; they have little or no impact on the physical structure; they can be embedded or bonded to the exterior of the pipeline; they have compact electronics and support hardware; they can be easily multiplexed, significantly reducing cost and top side control room power and space; they have high sensitivity and are multifunctional, they can measure strain, temperature, pressure, and vibration; they require no electric current and are immune to electromagnetic interference (EMI); they are safe to install and operate around explosives or flammable materials.

Some example applications for the monitoring and maintenance system of the invention thus include a variety of different areas of traditional concern. The possibility of deepwater riser fatigue failure is of concern due to vibration induced by vessel/rig motion and ocean currents. Deepwater drilling and production riser instrumentation has been demonstrated with fiber optics. Ruggedized cabling and connectors have been demonstrated. Early field trials with fiber optic sensors on several drilling risers have been successfully completed with sensors attached to risers deployed in water depths up to 7,000 feet. A rig site fatigue monitoring tool has been developed which processes the measured data and displays fatigue information in real time. Pipeline pressure monitoring was demonstrated by placing sensors on the exterior of the Troika pipeline and monitoring the pressurization processes. Deepwater SCR instrumentation efforts are underway for Gulf of Mexico projects where full design maturity has been demonstrated. Recent monitoring efforts have been accomplished with cryogenic temperature monitoring on LNG pipelines. Temperature, strain and heat flux were successfully demonstrated.

the present inventive method, a monitoring system is installed on the pipeline for measuring at least one parameter of interest selected from the group consisting of temperature, pressure, flow and level, the monitoring system including a plurality of monitoring sensors placed at selected locations along the pipeline, the monitoring sensors preferably comprise a fiber optic distributed sensor array. A series of measurements is taken using the monitoring sensors in real time. The measurements are analyzed to identify anomalous conditions existing in the pipeline being monitored. Autoadaptive corrective action is implemented based upon the real time measurement of he parameter of interest. Preferably, the pipeline is an undersea pipeline and the pipeline is conducting production fluid from an oil or gas well. The anomalous condition being analyzed is related to a build up of one or more undesirable materials within the interior of the pipeline selected from the group consisting of paraffins, asphaltenes, scale, water, hydrates, and mixtures thereof. The fiber optic distributed array is used to measure temperature on the outside of the pipeline at selected spaced apart locations. The temperature measurements are used to prepare a temperature profile, the profile being prepared in real time using a computer. The step of implementing an autoadaptive corrective action based upon the real time measurement of the parameter of interest and can include the step of treating the pipeline by introducing a chemical agent into the interior of the pipeline to reduce or prevent the accumulation of material within the pipeline. This step can also include the step of applying heat by means of an external heat source to the exterior of the pipeline as a further example of autoadaptive corrective action.

Returning to FIG. 1 of the drawings the pipeline 13 under consideration is an element of a subsea oil and gas production, collection, and shipping facility, including an offloading system, such as a buoy or platform offloading system 15. Pipeline leads normally extend from the subsea wells 17 to a manifold (not shown) from which flow lines bring the production fluid to a buoy or platform for transport. Such product flowlines are typically metal pipes which are sometimes equipped with intermediate floatation devices to provide a suitable contour or configuration to the flowlines.

As discussed above, the method of the invention is particularly useful for monitoring such a pipeline for accumulation within the pipeline of materials selected from the group consisting of paraffins, asphaltenes, scale, water, hydrates, and mixtures thereof.

FIG. 3 shows a cross section of the pipeline 13. The pipeline 13 includes a continuous rugged optical cable 19 which may be embedded in a cable tray 21 and filled with material for further protection. A field joint 23 covers the area indicated up to the surface of concrete coating for protection. As shown in FIG. 3, the installation also includes a protective fiberglass/epoxy wrap with embedded fiber optic sensors 25. The sensors include at least temperature sensors and the installation may also include the additional layer of insulation, as illustrated in FIG. 3. A heater 27 may also be present.

In the practice of the present invention, a sensor array is preferably used along a selected length of the pipeline 13, preferably along the majority of its length. While various means of making temperature measurements can be used as the sensor array 25, preferably the sensors are part of a fiber optic distributed sensor array. Such fiber optic distributed sensor arrays are known in the prior art and are commercially available from Astro Technology of Houston, Tex.

Preferably the sensor array consists of a fiber optic cable and temperatures sensors distributed along the cable. Preferably the sensors are located at intervals of somewhere between about 1 and 10 meters apart on the pipeline.

The system of the invention also includes all of the hardware, including a computer, and software necessary, to practice the method of the present invention. The distributed sensor array can also include one or more light sources, amplifiers, switching devices, and filters. The array can include one or more interfaces to at least one computer. The computer can include a memory, a information storage device, at least one output device, a communications interface, and any other hardware or software necessary to the practice of the method of the present invention.

In the method of the present invention, at least two measurements of the temperature of the pipe in the pipeline are made. Preferably a great many more measurements are made. In one preferred embodiment a measure is made at predefined increments along the entire length of the pipeline. Using the computer, the measurements are used to prepare a temperature profile, preferably in real time, of the outer surface of the section of pipeline being monitored by the method of the present invention.

It is also generally necessary that the temperature of the fluid entering the pipeline be measured, preferably at a point at or just upstream from the section of the pipeline to be monitored. Preferably, additional measurements of the temperature of the fluid entering the pipeline are also made. Such measurements can be made using any method of measuring the temperature of a fluid passing through a pipe known to those of ordinary skill in the art.

The fluid entering the pipeline 13 can be a single phase, a two phase or other multi-phase mixture. Production fluid can typically have up to three phases of non-solid materials: hydrocarbons, aqueous solutions, and gas. The production fluid can include solids, some actually exiting the well as solids and other solids precipitating due to changes in temperature, pressure or production fluid composition.

The production fluids, as produced, are quite warm. However, as they are transported along a pipeline that is at a very low depth, the fluids can become very cold. In the method of the present invention, the rate of transfer of heat between the interior and exterior of the pipeline is one method which can be used to determine the location and type of deposit, if any, on the interior of a pipeline.

For example, for any given pipeline, a history of the pipeline can be used to generate a model for detecting deposits on the interior surface of the pipeline. In this model, the rate of heat transfer across the pipe is measured along the length of interest of the pipeline. A decrease in the rate of transfer is indicative of a deposit. In one embodiment, a second temperature sensor array is run so that one array is along the top of the pipeline and the second is along the bottom. A difference in the rate of heat transfer between the upper and lower array could indicated a section of the pipeline wherein heavy solids were sitting on the bottom of the pipeline rather than being deposited around the circumference of the pipeline or the more likely occurrence of a “holding up” of a denser phase of material, usually water where the continuous phase is primarily gas and hydrocarbons.

Hydrates are a particular problem with undersea pipelines that are very deep. Hydrates are adducts of water and methane and/or other hydrate formers which can form when water comes into contact with methane at low temperatures and pressures sufficient to allow for the hydrogen bonding between the oxygen in water and the methyl hydrogens. Undersea pipelines often follow the contours of the ocean bottoms. When sufficient water is held up in a pipeline as a separate phase and methane is, in effect, passed through the water phase, hydrates are particularly likely to form.

The method of the present invention can be used to predict, detect and treat both the holding up of water as a separate phase in the pipeline and the formation of hydrates in a pipeline. The rate at which deposits accumulate could also be used to qualitatively identify deposits. Based on the temperature of the fluid in the pipeline and the characteristics of the production fluid, it could be determined whether a material depositing on the pipe was either paraffins or asphaltenes, for example.

Other variables can also be used to model amount and type of deposits. For example, if a pressure drop was also measured for a given section of pipeline, the thickness of the deposit could be estimated. If the thickness of the deposit is known, and the rate of heat flow through the deposit measured, then it could be determined which of the possible materials was causing the deposits as each possible material could have a different insulative property. For example, paraffins could be a better insulator than asphaltenes and thus the two materials would be distinguishable. In systems where the temperature of the entering fluid varies, it could be desirable to measure the temperature of the entering fluid and use variations therein in interpreting changes in the rate of heat passing through the walls of a pipeline. This measurement could be used in preparing the models of the present invention.

If the presence of a deleterious material is detected or predicted, the method of the present invention also includes performing an operation to reduce or eliminate the deposit. While this could include traditional mechanical interventions such as a pigging operation, preferably, the action will be non mechanical and relatively non-disruptive in nature. For example, if it were determined that there was an asphaltene deposit in the pipeline, then a chemical agent useful for reduce asphaltene deposits could be used. The effect of chemical agents on deposits could also be used to prepare a predictive model for qualitative determinations of deposits. The additives could be added in any way and at any location known to be useful to those of ordinary skill in the art of maintaining pipelines to be useful.

The method of the invention thus envisions various techniques for gathering needed sensor data. For example, it is envisioned to affix or otherwise put into contact a sensor array with a pipeline at the exterior surface of the pipe. In an alternative embodiment, the array can be inserted into the wall of the pipe or beneath an insulating lining, such as is illustrated in FIG. 3. Another installation might involve a sensor array which is placed into contact with a temperature conducting substrate that is in contact with the pipe of a pipeline.

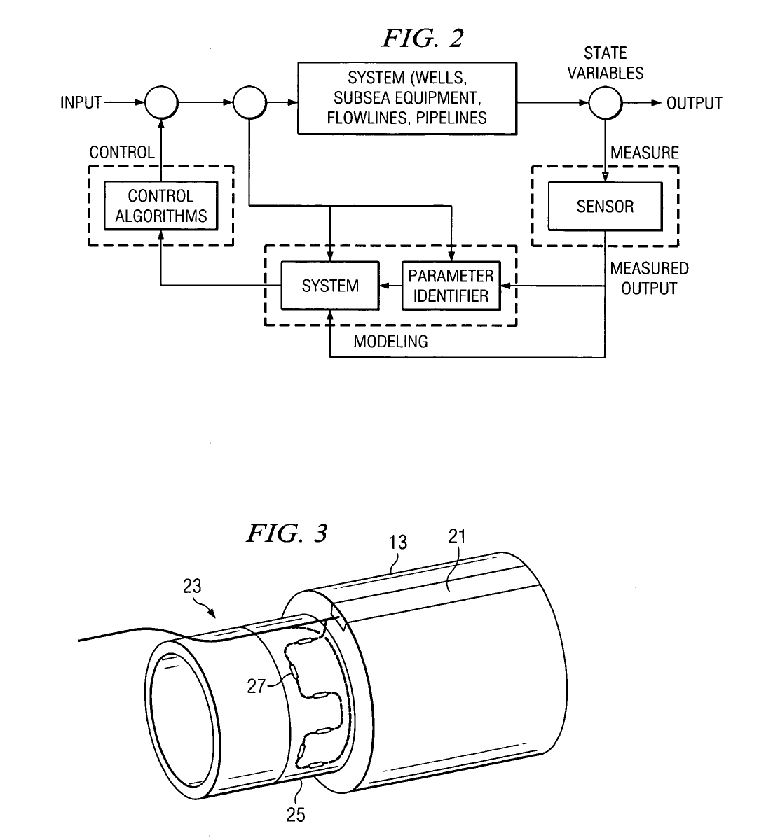

FIG. 2 of the drawings is a simplified schematic of the type of computer modeling which is envisioned for an oil and gas production operation represented as a feedback control process involving measurement, modeling and control. With reference to FIG. 3, the control loop will be illustrated with respect to two types of deleterious conditions being monitored by the system, a model for hydrate mitigation and a model for slug mitigation:

Control Loop Example for Hydrate Mitigation:

Measure—Sensors provide data on variables such as temperature, flow and pressure that can be used to detect hydrate formation.
Model—This data is used by the SCADA (supervisory control and data acquisition) software to determine if and where hydrate formation is occurring. This data is presented to the operator and stored as well as used by the control section.
Control—Based on the output of the modeling section, the control section takes action (addition of MEG) to reduce hydrate buildup as necessary.
   Control Loop Example for Slug Mitigation:
Measure—Sensors provide data on variables such as level, flow and pressure that can be used to detect slugs or conditions conducive to slug formation.
Model—This data is used by the SCADA (supervisory control and data acquisition) software to determine if and where slugs are present. This data is presented to the operator and stored as well as used by the control section.
Control—Based on the output of the modeling section, the control section takes action (valve control) to eliminate or prevent the formation of slugs as necessary.

An invention has been provided with several advantages. Smart pipeline implementation is suitable to a large number of oil and gas applications. Longer, trouble free service life of the pipeline operation will result by application of this technology. The smart pipeline technology allows for autoadaptive measures to ensure trouble free operation of the entire pipeline system. Realtime monitoring and control of flow assurance issues drive the development of smart pipelines in oil and gas reservoirs for both onshore and offshore deepwater environments. Significant cost savings can result and improved reliability can be achieved. The components of smart pipeline methods have been investigated and implemented on various full scale projects. Design maturity with the instrumentation and control methods has been achieved. The systems have been designed for rugged, long term usage. Many years of trouble free operation are expected.

The monitoring and maintenance system of the invention provides problem prevention or mitigation with early detection and proactive intervention to monitored concerns. Instrumentation methods are new, innovative and proven in field monitoring operations. Predictive tools for pipeline operators have been developed for fatigue analysis and pipeline health. The method incorporates a smart field control system with automated data analysis and response. The ultimate goal of an integrated operations control system capable of providing optimum performance is achievable.

The method of the invention are particularly useful with pipelines transporting production fluid produced from oil and gas wells, particularly offshore produced oil and gas. While particularly useful for oil and gas productions, the method of the present invention can also be used with any pipeline carrying a fluid (either liquid or gas) that, for example, causes deposits within the pipeline. Practically any pipeline carrying a fluid that includes dissolved solids capable of precipitating to form deposits could be monitored using the method of the present invention. In another example, the production tubing in an oil well or even the wellbore could also be monitored using the techniques of the invention.

While the invention has been shown in only one of its forms, it is not thus limited but is susceptible to various changes and modifications without departing from the spirit thereof.

1. A method for monitoring and maintaining a pipeline, the method comprising the steps of:
installing a monitoring system for measuring at least one parameter of interest, the monitoring system including a plurality of monitoring sensors placed at selected locations along the pipeline;
taking a series of measurements using the monitoring sensors in real time;
analyzing the measurements to identify anomalous conditions existing in the pipeline being monitored; and
implementing an autoadaptive corrective action based upon the real time measurement of the parameter of interest.

2. The method of claim 1, wherein the parameters being measured are selected from the group consisting of hydrate build up and prediction; free span and vortex induced vibration identification; leak detection; slug prediction, detection and suppression; fatigue life prediction; pig tracking; wax/paraffin build up prediction; pipeline cool down; earthquake or earth movements; river/stream crossing integrity; solids/liquids accumulations in prone areas; pipeline displacements for stress, strain, fatigue, and ;insulation anomalies in LNG pipelines.

3. The method of claim 2, wherein the pipeline is a subsea pipeline which is producing fluid from an oil or gas well.

4. The method of claim 3, wherein at least certain of the monitoring sensors placed at selected locations along the pipeline are fiber optic sensors.

5. A method for monitoring for the build up of materials within the interior of the pipeline and for implementing corrective action when anomalous conditions are detected, the method comprising the steps of:
installing a monitoring system for measuring at least one parameter of interest selected from the group consisting of temperature, pressure, flow and level, the monitoring system including a plurality of monitoring sensors placed at selected locations along the pipeline, the monitoring sensors comprising a fiber optic distributed sensor array;
taking a series of measurements using the monitoring sensors in real time;
analyzing the measurements to identify anomalous conditions existing in the pipeline being monitored; and
implementing an autoadaptive corrective action based upon the real time measurement of the parameter of interest.

6. The method of claim 5, wherein the pipeline is an undersea pipeline and the pipeline is conducting production fluid from an oil or gas well.

7. The method of claim 6, wherein the anomalous condition being analyzed is related to a build up of one or more undesirable materials within the interior of the pipeline selected from the group consisting of paraffins, asphaltenes, scale, water, hydrates, and mixtures thereof.

8. The method of claim 7, wherein the fiber optic distributed sensor array is used to measure temperature on the outside of the pipeline at selected spaced apart locations,

9. The method of claim 8, wherein the temperature measurements are used to prepare a temperature profile, the profile being prepared in real time using a computer.

10. The method of claim 9, wherein the step of implementing an autoadaptive corrective action based upon the real time measurement of the parameter of interest includes the step of treating the pipeline by introducing a chemical agent into the interior of the pipeline to reduce or prevent the accumulation of material within the pipeline.

11. The method of claim 10, wherein the step of implementing an auto adaptive corrective action based upon the real time measurement of the parameter of interest includes the step of applying heat by means of an external heat source to the exterior of the pipeline.
